(19) United States
(12) Patent Application Publication
(10) Pub. No.: US 2004/0028201 A1
(43) Pub. Date: Feb. 12, 2004

(54) Networkwide final customer administration via provider administration technique

(76) Inventors: Joachim Huttel, Munchen (DE); Michael Moeller, Grobenzell (DE); Irena Romanski, Egling (DE)

Correspondence Address: Kevin R. Spivak, Morrison & Foerster, 1650 Tysons Blvd, Suite 300, McLean, VA, 22102, US

(21) Appl. No.: 10/221,266

(22) PCT Filed: May 2, 2001
(86) PCT No.: PCT/DE01/01657

(30) Foreign Application Priority Data
May 4, 2000 (DE) 100 21 550.5

(51) Int. Cl. H04M 3/42; H04M 3/00; H04M 5/00

(52) U.S. Cl. 379/201.11; 379/265.01

(57) ABSTRACT

The invention relates to a management device (5) which is used to manage and modify data and operational functions of switching points in a telephone network. The invention also relates to a method employed in said management device (5). The inventive method and device enable public networkwide administration by the public operator and private networkwide administration by the end customer using an administration system with guaranteed safety mechanisms.

The present invention relates to an administrative device for the administration and modification of data and operating functions of switching centers in a telephone network, as it is described in the preamble of the attached claim 1, and to a method used in this administrative device, as it is described in the preamble of the attached claim 9.

In the public telephone network, the individual subscribers are connected with integrated switching centers. The administration and modification of data and operating functions of switching centers takes place through administrative commands of the control software. Such administrative tasks can be, for example, logical setup, modification or deletion of a subscriber terminal.

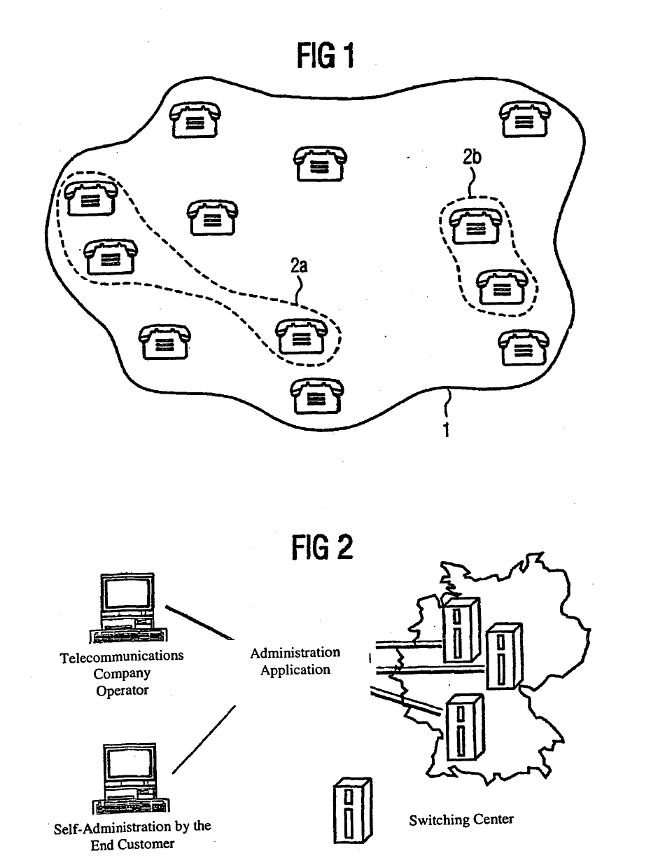

FIG. 1 shows a virtual private network that is a service in the public telephone network. The virtual private networks 2a and 2b allow a virtual dialing network that is implemented in the existing public telephone network 1 by changing the value of telephone numbers in the switching centers of the public network. End customers of this service can create or maintain a private telephone number plan that appears suitable to them. The private telephone numbers are converted to the telephone numbers of the connection in the public telephone network with which the called private network is connected. In public switching technology, it is usual that the administration and modification of data and operating functions of switching centers is carried out by the public operator. However, for structuring virtual private telephone number plans or for administering subscriber data in a virtual private network, it is desirable that end customers themselves are able to structure their configurations network-wide.

In the area of public switching technology, the only solutions available until now have been those in which there are two separate products—for public administration and for end-customer administration. End-customer administration is only possible for those functions administered in the same switching center with which the end customer is connected. Until now, network-wide end-customer administration existed only in private branch exchanges.

The problem here lies in ensuring that security mechanisms only allow private end customers to configure for their sectors a selected segment. In particular, access to public data and to data of other end customers must be prevented. At the same time, parallel development of two different products, for public administration technology and for end-customer administration technology, should be avoided to prevent significant costs.

The task of the present invention is therefore to create a method that can be used in this switching center, which allows public network-wide administration by the public operator and private network-wide administration by the end customer by way of one and the same administration system while guaranteeing security mechanisms.

This task is accomplished by means of an administrative device according to the attached claim 1 and by a method used in this administrative device according to the attached claim 9.

According to the present invention, the administrative commands required for an administrative task or operating function are automatically computed or generated in the main office by the administrative device according to the invention. The administrative commands that relate to several switching centers are coordinated and sent to all the affected switching centers. Public network-wide administration by the public operator, as well as private network-wide administration by the end customer, takes place by means of the administrative device. A checking device checks whether an operator gaining access is authorized to administer and modify data and operating functions.

In this way, only one product is needed for administration by the public operator and the end customer. This results in significant savings both in the development of the product and in the maintenance of and adaptation to future features. Since the public operator works with the same interfaces as the end customer, any correction of errors or re-setting after errors by the public operator is possible in a very simple and inexpensive manner. The hardware that offers the network connection to the entire public network is in the control of the public operator and can be expanded in accordance with network requirements and adapted to the state of the art. Customers can easily administer their private features (such as the network-wide telephone number plan, network-wide subscribers/features) themselves without having to involve a public operator. In case of conflict, however, the public operator can easily intervene or give advice. The public operators have complete control over the use of end-customer administration, since only they can determine and change access rights and access options. The end customer therefore cannot do any harm to the public hardware or software functions (such as immoderate memory capacity consumption in the public switching center, or access to public subscribers or subscribers of another end customer).

The present invention is explained in greater detail below, on the basis of preferred exemplary embodiments, with reference being made to the attached drawings.

FIG. 1 shows two virtual private networks in the public telephone network.

FIG. 2 shows the principle of network-wide end-customer administration.

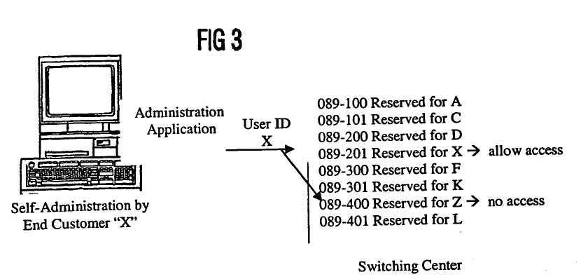

FIG. 3 shows the sequence of access protection, using the example of Centrex.

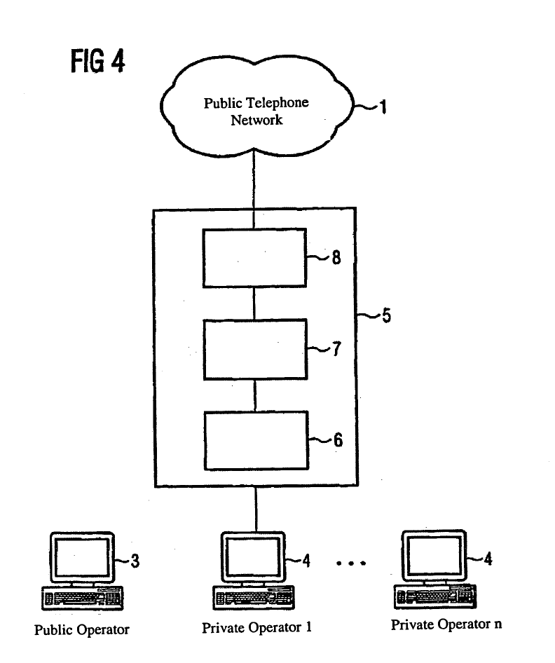

FIG. 4 shows a schematic representation of the administrative device according to the invention.

As already mentioned at the beginning, on the basis of FIG. 1, several telephone objects (such as terminals or private branch exchanges) can be organized into group 2A or 2B in the Centrex service. At the same time, the functionality of a private branch exchange is made available to a company by a switching center, without the company having to acquire a private branch exchange. The number of telephone objects that belong to a group is unlimited or it can be stipulated by the telecommunications company. A group can also extend network-wide, via several switching centers, in which case the telephone objects then belong to the branches of a company.

FIG. 2 shows the principle of network-wide end-customer administration. The public operator and the end customer access the switching centers by way of the same administration application. End customers are allowed access only to the data assigned to them by the public operator (symbolized by the thin access lines). Security is assured in two stages, on the PC system and in the switching centers themselves. For this purpose, a user identification (ID) is assigned to every end customer.

The sequence of access protection, using Centrex as an example, is shown in FIG. 3. End customer X accesses a switching center, using its user IDX, in order to reach a Centrex subscriber at a telephone number. The switching center software checks whether access to the desired telephone number can be granted to this user with its user ID, based on the assignment of telephone numbers made by the public operator.

As the example shows, access to the switching centers involved is carried out by means of an administration system that is used jointly by both the public and the private side. At the same time, special security-related precautions are taken so that data protection is assured and the end customer cannot access data that is assigned either to the public side or to other end customers. For this purpose, a coupled security mechanism is used, one part of which is located in the administration system itself. The other essential part is used in the switching centers that are involved. Installing the security mechanism is the responsibility of the public operator.

FIG. 4 shows an example of the administrative device according to the invention. The public operator 3 and private operators 4 (end customers) access the administrative device 5 using their terminals. The checking device 6 checks whether the accessing operator is authorized to administer and modify the data and operating functions. The data and operating functions are administered and modified by the authorized operators using commands entered into the control device 7. The coordination device 8 coordinates the data and operating functions that relate to several switching centers, and after information concerning the data and operating functions to be modified has been entered, the corresponding administrative commands are automatically calculated for all the switching centers affected, and sent to the switching centers affected.

The administrative commands are automatically calculated or generated at the main office by the administrative device according to the invention and sent to all the switching centers affected. The logic for each task of network-wide administration is anchored in the applications software. The switching centers can be administered network-wide by authorized operators by entering commands over a terminal, which means that operating functions, such as setting up terminals or assigning certain authorizations to terminals, i.e., subscribers, for example with regard to features, can be carried out. Several groups can be organized in switching centers, each of them having different access authorizations. The group ID is assigned uniformly for all members of a group in the individual switching centers in which the group is present, and thereby a network-wide group is formed (for example the group of all branch offices of a company present in the telephone network). This is done through appropriate commands, which are set down in the corresponding switching center for every member of a group. The network administrators who assign the identification (ID) themselves have access to all administratively protected switching centers and groups.

Since the end customer accesses the same Centrex application as the public operator, all the user interfaces are also the same. However, from the outset, areas related to security, such as setting of charges, are not displayed to the end customer on the user interface, so that in addition to the checking procedures that occur in the switching centers, additional security is provided on the PC side. The settings determining which data is visible on the interface and which data is not, is made by the public operator. The Centrex data and data sectors that can be subject to protection (depending on the setting made by the public operator) are telephone numbers and telephone number ranges, the number of TDUs (Translator Data Units), the number of groups accepting calls, the number of Central call types, the number of order groups, the number of queues, the total size of the queue group in the Centrex group and the number of supervisor groups. For example, it is possible for private operators to assign different access authorizations to their branch offices.

1. Administrative device (5) for the administration and modification of data and operating functions of switching centers in a telephone network (1), the data and operating functions of the switching centers being administered and modified through administrative commands that they receive from the administrative device (5), with a control device (7), in which data and operating functions of the switching centers are administered and modified by means of authorized operators entering commands over terminals (3, 4),
characterized by
coordination means (8) for coordinating data and operating functions that relate to several switching centers, these coordination means automatically calculating the corresponding administrative commands for all the switching centers affected after information concerning the data and operating function to be modified has been entered, and sending them to the affected switching centers, and
a checking device (6) for checking whether an accessing operator (3, 4) is authorized to administer and modify the data and operating functions.

2. The administrative device (5) according to claim 1,
characterized in that
information required for the administration and calculation of the administrative commands is stored at the main office in a control device (7).

3. The administrative device (5) according to claim 1 or 2,
characterized in that
objects in the telephone network are organized into groups and the checking device (4) [sic] checks whether an accessing operator (3, 4) is authorized to administer and modify the data and operating functions of a certain group.

4. The administrative device according to one of the preceding claims,
characterized in that
some terminals in the telephone network belonging to a virtual private branch exchange are brought together into a group.

5. The administrative device according to one of the preceding claims,
characterized in that
it is used for administering and modifying routing tables.

6. The administrative device according to one of the preceding claims,
characterized in that
a graphic user interface is available for administering and modifying data and operating functions of the switching centers.

7. The administrative device according to one of the preceding claims,
characterized in that
it receives and processes feedback from the corresponding switching centers concerning implementation of the administrative commands sent.

8. The administrative device according to one of the preceding claims,
characterized in that
in order to identify them clearly, each telephone object is provided with a group identification.

9. Method for the administration and modification of data and operating functions of switching centers in a telephone network, the data and operating functions of the switching centers being administered and modified by means of administrative commands, in which data and operating functions of switching centers are administered and modified by authorized operators entering commands over terminals (3, 4),
characterized in that
data and operating functions that relate to several switching centers are coordinated, whereby after information concerning the data and operating functions to be changed has been entered, the appropriate administrative commands are automatically calculated for all the switching centers affected, and sent to the affected switching centers, and the system checks whether an accessing operator (3, 4) is authorized to administer and modify the data and operating functions.

10. The method according to claim 9,
characterized in that
information required for the administration and calculation of the administrative commands is stored at the main office in a control device (7).

11. The method according to claim 9 or 10,
characterized in that
objects in the telephone network are organized into groups and the system checks whether an accessing operator (3, 4) is authorized to administer and modify the data and operating functions of a certain group.

12. The method according to one of claims 9 to 11,
characterized in that
some terminals in the telephone network belonging to a virtual private branch exchange are brought together into a group.

13. The method according to one of claims 9 to 12,
characterized in that
routing tables are used to administer and modify operating functions.

14. The method according to one of claims 9 to 13,
characterized in that
a graphic user interface is used to administer and modify data and operating functions of the switching centers.

15. The method according to one of claims 9 to 14,
characterized in that
feedback from the corresponding switching centers concerning implementation of the administrative commands sent is received and processed.

16. The method according to one of claims 9 to 15,
characterized in that
in order to identify them clearly, each telephone object group is provided with a group identification.
